(19) United States
(12) Patent Application Publication
(10) Pub. No.: US 2025/0297647 A1
(43) Pub. Date: Sep. 25, 2025

(54) BEARING DEVICE WITH INTEGRATED ELECTRICAL INSULATION, NOTABLY FOR AN ELECTRIC MOTOR OR MACHINE

(71) Applicant: AKTIEBOLAGET SKF, GOTEBORG (SE)

(72) Inventors: Benoit ARNAULT, Saint-Cyr-sur-Loire (FR); Mickael CHOLLET, Joué-Lès-Tours (FR); Jean-Marie GERARD, Joué-Lès-Tours (FR)

(21) Appl. No.: 19/077,186

(22) Filed: Mar. 12, 2025

(30) Foreign Application Priority Data
Mar. 21, 2024 (FR) 2402800

(51) Int. Cl. F16C 41/00; F16C 19/06

(52) U.S. Cl. CPC F16C 41/002; F16C 19/06; F16C 2380/26

(57) ABSTRACT

A bearing device includes a bearing having first and second rings, a bushing, and an electrically insulating insert overmolded between and connecting the bushing and a second radial side of the second ring. The second radial side has a cylindrical central portion and a cylindrical lateral part axially and radially offset from the cylindrical center portion. A connection face extends from the first cylindrical lateral part to the cylindrical center portion, and has a plurality of circumferentially spaced grooves. One of a plurality of first ribs of the electrically insulating bushing extends into a respective one of the plurality of first circumferentially spaced grooves. At least a portion of the connection face has a radial component.

### CROSS-REFERENCE

This application claims priority to French patent application no. 2402800 filed on Mar. 21, 2024, the contents of which are fully incorporated herein by reference.

### TECHNOLOGICAL FIELD

The present disclosure relates to the field of bearings that are used in particular in electric motors, electric machines and associated apparatus.

### BACKGROUND

In an electric motor or machine, at least one rolling bearing is mounted between the housing of the electric motor or machine and the rotary shaft in order to support this shaft. During operation, when the shaft is rotating, a difference in electrical potential can occur between the shaft and the housing of the electric motor or machine, thereby generating an electric current between the inner ring of the rolling bearing, which is rigidly connected to the shaft, and the outer ring, which is rigidly connected to the housing. The electric current flowing through the components of the rolling bearing can damage these components, notably the rolling elements and raceways provided on the inner and outer rings. Electrical discharges can also generate vibrations.

To overcome these drawbacks, it is known practice to replace the rolling elements of the bearing, which are made of the same steel as the inner and outer rings, with rolling elements made from ceramic. The expression “hybrid rolling bearing” is then generally used. However, such a hybrid rolling bearing is relatively expensive.

In order to overcome the aforementioned drawbacks, it is also known practice to equip the outer ring of the rolling bearing with an insulating sleeve provided with a bushing and with an insulating insert made of an electrically insulating material and positioned radially between the outer ring and the bushing. In order to attach the insulating insert to the outer ring and to the bushing without any additional elements or specific machining on the outer ring, the insulating insert can be overmolded. However, with such a solution, relative uncoupling of the insulating insert and the bushing can occur during operation.

### SUMMARY

The present disclosure therefore aims to overcome the aforementioned drawbacks by providing a bearing device which has a simple and economical design.

A first aspect of the disclosure relates to a bearing device comprising a bearing provided with a first ring and a second ring that are able to rotate relative to one another. The device further comprises at least one insulating sleeve mounted on the second ring of the bearing. The insulating sleeve has a bushing and an insulating insert positioned radially between the second ring of the bearing and the bushing. The insulating insert is made of an electrically insulating material.

The second ring comprises an outer surface and an inner surface opposite to the outer surface, which delimit the radial thickness of the outer second ring. The insulating insert is overmolded on the bushing and at least on one of the inner and outer surfaces of the second ring of the bearing.

According to an overall feature, the inner or outer surface of the second ring has a tiered shape with a cylindrical main part and at least a first cylindrical lateral part which is disposed axially to one side of the main part and is radially offset, on the other, outer or inner, surface of the second ring, with respect to the main part.

According to another overall feature, the inner or outer surface of the second ring is additionally provided with a first connection face extending between the first cylindrical lateral part and the cylindrical main part.

According to yet another overall feature, at least the first connection face is provided with a plurality of first grooves which are spaced apart from one another in the circumferential direction and inside each of which extends a rib, of complementary shape, for attaching the insulating insert.

This provides a bearing device that has integrated electrical insulation and is economical in relation to conventional hybrid rolling bearings. Furthermore, the device is easy to manufacture and assemble in the associated electric motor or machine.

Furthermore, providing grooves on the inner or outer surface of the second ring of the bearing makes it possible to afford a good rigid connection with the insulating insert insofar as the attachment ribs are formed inside them during the overmolding. The risk of relative movements between the insulating insert and the second ring in the axial and circumferential directions is particularly limited, notably in the event of temperature variations.

“Axial direction” is understood to mean the direction parallel to the axis of the bearing device. “Circumferential direction” is understood to mean the direction that is perpendicular both to the axial direction and to a radius of the bearing device, in other words tangent to a circle centered on the axis of the bearing device.

Moreover, the provision of grooves on the first connection face of the inner or outer surface of the second ring of the bearing makes it possible to limit the variation in material thickness around the area provided with the grooves, in relation to a disposition of the grooves in the main part in the area adjacent to the first connection face. This limits the occurrence of stress concentrations in the areas of reduced thickness of the second ring.

Preferably, the first connection face of the inner or outer surface of the second ring extends at least partially radially from the cylindrical main part. According to a first design, the first connection face extends at least partially obliquely from the cylindrical main part, i.e. both radially and axially. According to a second design, the first connection face extends at least partially purely radially from the cylindrical main part.

Each of the first grooves of the first connection face of the inner or outer surface of the second ring may be circumferentially delimited by two facing lateral flanks. In one embodiment, the inner or outer surface of the second ring is provided solely with the cylindrical main part and with the first cylindrical lateral part. In another embodiment, the inner or outer surface of the second ring is provided with a second cylindrical lateral part which is radially offset, on the other, outer or inner, surface of the second ring, with respect to the main part, the first and second cylindrical lateral parts being disposed axially one on each side of the cylindrical main part. The first and second lateral parts may have identical or different diameters.

In this case, the inner or outer surface of the second ring is provided with a second connection face extending between the second cylindrical lateral part and the central part. With preference, the second connection face is provided with a plurality of second grooves which are spaced apart from one another in the circumferential direction and inside each of which extends a rib, of complementary shape, for attaching the insulating insert.

According to a particular design, the cylindrical main part of the inner or outer surface of the second ring may be provided with a plurality of grooves which are spaced apart from one another in the circumferential direction and inside each of which extends a rib, of complementary shape, for attaching the insulating insert.

If the insulating insert is made of a synthetic or elastomer material, it makes the device relatively insensitive to temperature variations.

In a particular embodiment, the bushing is made of a metal material. The bushing can thus be easily machined to a predetermined radial tolerance.

According to a first design, the bushing delimits the outer surface of the device. In this case, the second ring is the outer ring of the bearing. According to an alternative second design, the bushing delimits the inner surface of the device. In this case, the second ring is the inner ring of the bearing.

In a particular embodiment, the bearing comprises at least one row of rolling elements disposed between raceways of the first and second rings. The rolling elements can be made of a metal material.

The disclosure also relates to an electric motor comprising a housing, a shaft and at least one bearing device as defined above and mounted radially between the housing and the shaft.

### BRIEF DESCRIPTION OF THE DRAWINGS

The present disclosure will be better understood with reference to the detailed description of an embodiment, which is provided by way of a non-limiting example and is illustrated by the appended drawings, in which:

FIG. 1 is a half-view, in axial section, of a bearing device according to one exemplary embodiment of the invention.

FIG. 2 is a perspective view of the outer ring of the bearing device of FIG. 1.

FIG. 3 is a detail view of FIG. 2.

FIG. 4 is a perspective view of the outer ring of a bearing device according to another exemplary embodiment of the invention.

FIG. 5 is a detail view of FIG. 4.

FIG. 6 is a half-view, in axial section, of a bearing device according to another exemplary embodiment of the invention.

FIG. 7 is a perspective view of the outer ring of the bearing device of FIG. 6.

FIG. 8 is a detail view of FIG. 7.

### DETAILED DESCRIPTION

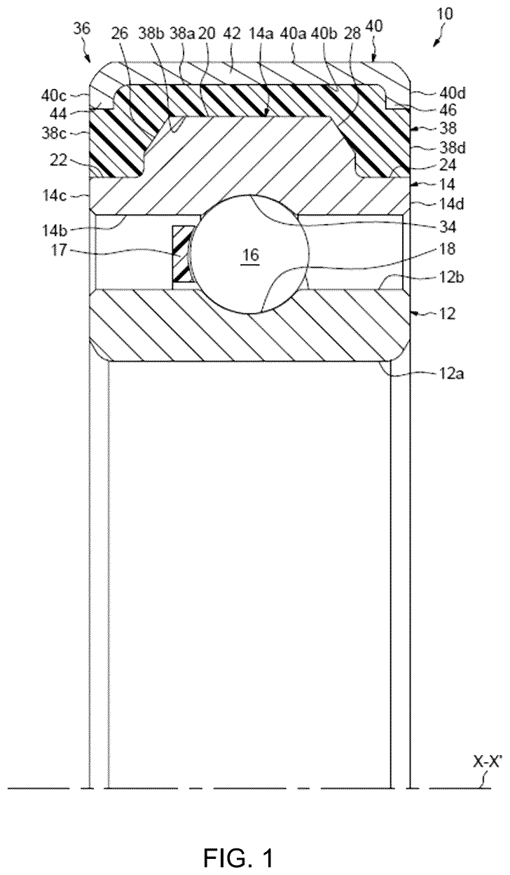

The bearing device illustrated in FIG. 1 comprises a bearing 10 having a first ring 12 and a second ring 14 that are able to rotate relative to one another about the axis X-X′ of the bearing. In the illustrated embodiment, the first ring 12 is the inner ring of the bearing and the second ring 14 is the outer ring. The inner ring 12 and outer ring 14 of the bearing are concentric and extend axially along the axis X-X′ of the bearing. The inner ring 12 and outer ring 14 are made of steel. The rings are of the solid type.

The bearing device is configured such that it does not conduct electric currents. The bearing device has integrated electric insulation.

In the illustrated exemplary embodiment, the bearing 10 also comprises a row of rolling elements 16, in this case balls, positioned radially between the inner ring 12 and outer ring 14. The rolling elements 16 are made of steel. The bearing 10 also comprises a cage 17 for maintaining the even circumferential spacing of the rolling elements 16. The bearing 10 can also be equipped with seals or sealing flanges.

The inner ring 12 has a cylindrical bore 12a, a cylindrical axial outer surface 12b radially opposite the bore 12a, and two opposite radial end faces (not referenced) axially delimiting the bore and the outer surface. The bore 12a and the outer surface 12b delimit the radial thickness of the inner ring 12. The bore 12a forms the inner surface of the inner ring. The inner ring 12 also has an inner raceway 18 for the rolling elements 16 that is formed on the outer surface 12b. The raceway 18 is directed radially outwards.

The outer ring 14 has a cylindrical axial outer surface 14a, a cylindrical bore 14b radially opposite to the outer surface 14a, and two opposite radial end faces 14c, 14d axially delimiting the outer surface and the bore. The outer surface 14a and the bore 14b delimit the radial thickness of the outer ring 14.

The outer surface 14a has a tiered shape. The outer surface 14a has an annular cylindrical central part 20 that has a relatively large diameter and first and second annular cylindrical lateral parts 22, 24 having a smaller diameter than that of the annular cylindrical central part 20 and that are disposed axially one on each side of the central part 20. The lateral parts 22, 24 are thus offset radially inwardly with respect to the central part 20, i.e. radially offset towards the bore 14b with respect to the central part 20.

The outer surface 14a also has a first connection face 26 extending between the first lateral part 22 and the central part 20. The first connection face 26 has a frustoconical part extending obliquely inwards from the central part 20 in the radial direction and outwards in the axial direction, and a radial part which extends from an edge of small diameter of the frustoconical part to the first lateral part 22.

The outer surface 14a also has a second connection face 28 extending between the second lateral part 24 and the central part 20. The second connection face 28 has a frustoconical part extending obliquely inwards from the central part 20 in the radial direction and outwards in the axial direction, and a radial part which extends from an edge of small diameter of the frustoconical part to the second lateral part 24. The outer ring 14 is symmetrical with respect to a radial midplane passing through the center of the rolling elements 16.

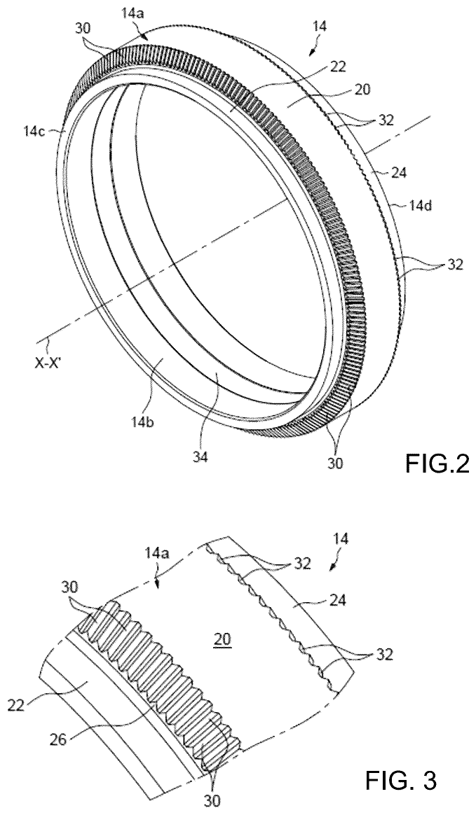

With reference to FIGS. 2 and 3, the outer ring 14 has first grooves 30 formed on the first connection face 26. The first grooves 30 are formed on the frustoconical part of the first connection face 26. The first grooves 30 extend radially inwards from the first connection face 26. The first grooves 30 are immediately adjacent to one another in the circumferential direction. Each first groove 30 is circumferentially delimited by two facing lateral flanks which have a rectilinear profile in axial section and are connected to one another.

The first grooves 30 are in this case formed all around the perimeter of the first connection face 26. As an alternative, the first grooves 30 could extend over an angular sector less than 360°, or be arranged in the form of groups of grooves spaced apart from one another in the circumferential direction. The first grooves 30 may be formed on the first connection face 26 by knurling.

The outer ring 14 also has second grooves 32 formed on the second connection face 28. The grooves 32 are formed on the frustoconical part of the second connection face 26. The second grooves 32 extend radially inwards from the second connection face 28. The second grooves 32 are immediately adjacent to one another in the circumferential direction. Each second groove 32 is circumferentially delimited by two facing lateral flanks which have a rectilinear profile in axial section and are connected to one another.

The second grooves 32 are in this case formed all around the perimeter of the first connection face 26. As an alternative, the second grooves 32 could extend over an angular sector less than 360°, or be arranged in the form of groups of grooves spaced apart from one another in the circumferential direction. The second grooves 32 may be formed on the second connection face 28 by knurling.

With reference again to FIG. 1, the outer ring 14 further comprises an outer raceway 34 for the rolling elements 16, which is formed on the bore 14b. The raceway 20 is directed radially inwards.

The bearing device also comprises an electrically insulating sleeve 36 mounted on the outer ring 14. The insulating sleeve 36 is mounted on the outer surface 14a of the outer ring 14. The insulating sleeve 36 is rigidly connected to the outer ring 14. The insulating sleeve 36 comprises a bushing 40 and an electrically insulating insert 38 positioned radially between the outer ring 14 and the bushing 40. The insulating insert 38 is overmolded on the outer ring 14 and on the bushing 40.

The bushing 40 is annular. The bushing 40 extends axially. The bushing 40 is made in this case in one piece. As an alternative, the bushing 40 could be made in multiple parts bearing against one another, for example two identical parts. The bushing 40 comprises an axial portion 42, a first radial flange 44 extending radially inwardly from one end of the axial portion 42, and a second radial flange 46 extending radially inwardly from the opposite end of the axial portion 42. In the exemplary embodiment illustrated, the radial flanges 44, 46 are annular. The radial flanges 44, 46 are spaced at a distance from the outer ring 14.

The bushing 40 has a cylindrical axial outer surface 40a, and a cylindrical channel 40b which is radially opposite the outer surface 40a. The channel 40b forms the inner surface of the bushing 40. The axial portion 42 of the bushing delimits the outer surface 40a and the channel 40b. The outer surface 40a and the channel 40b delimit the radial thickness of the bushing 40. The outer surface 40a of the bushing forms the outer surface of the bearing device 10. In other words, the outer surface 40a defines the outside diameter of the bearing device 10.

The bushing 40 also has two opposite radial end faces 40c, 40d axially delimiting the outer surface 40a. The end faces 40c, 40d delimit the axial length of the bushing. The end face 40c is delimited by the radial flange 44, and the end face 40d is delimited by the radial flange 46. More specifically, the end face 40c is delimited by the outer face of the radial flange 44, and the end face 40d is delimited by the outer face of the radial flange 46.

In the exemplary embodiment illustrated, the end faces 40c, 40d of the bushing are respectively coplanar with the end faces 14c, 14d of the outer ring. As an alternative, other arrangements could be provided. For example, the bushing 40 could have a smaller or greater axial dimension and could remain axially set back from the faces 14c, 14d of the outer ring, or could project outward of the faces.

The insulating insert 38 is made of an electrically insulating material, for example, of a synthetic material, such as a PEEK or a PA46, or it can be made of an elastomer material, such as rubber.

The insulating insert 38 is positioned radially between the outer surface 14a of the outer ring and the bore 40b of the bushing. The insulating insert 38 covers the outer surface 14a of the outer ring. In this case, the insulating insert 38 completely covers the outer surface 14a in the axial and circumferential directions.

The insulating insert 38 also covers the channel 40b of the bushing. The insulating insert 38 in this case also completely covers the channel 40b in the axial and circumferential directions. The insulating insert 38 also covers the inner face of the radial flange 44, 46 of the bushing. The insulating insert 38 also covers the free end of the radial flange 44, 46 of the bushing.

The insulating insert 38 is annular. The insulating insert 38 extends axially. The insulating insert 38 comprises a cylindrical axial outer surface 38a, a cylindrical channel 38b radially opposite the outer surface 38a, and two opposite radial end faces 38c, 38d axially delimiting the channel and the outer surface. The radial end faces 38c, 38d axially delimit the insulating insert 38. The outer surface 38a and the channel 38b delimit the radial thickness of the insulating insert. The outer surface 38a is in radial contact with the channel 40b of the bushing. The outer surface 38a is also in radial contact with the free end of each radial flange 44, 46 of the bushing. The outer surface 38a has a tiered shape. The bore 38b is in radial contact with the outer surface 14a of the outer ring. The channel 38b has a tiered shape.

In the exemplary embodiment illustrated, the faces 14c, 38c, 40c and 14d, 38d, 40d of the outer ring, of the insulating insert and of the bushing are respectively coplanar. As an alternative, other arrangements could be provided. For example, the insulating insert 38 could have a reduced axial dimension and remain axially set back from the faces 14c, 14d of the outer ring. Alternatively, the insulating insert 38 could have a greater axial dimension and axially project from the faces 14c, 14d of the outer ring. In this case, the insulating insert 38 can at least partly cover these faces 14c, 14d. As a variant, the insulating insert 38 could at least partly cover the faces 40c, 40d of the bushing.

In another alternative, or in combination, the bushing 40 could axially project from the insulating insert 38 relative to the faces 38c and 38d, or could remain axially set back from these faces.

The insulating insert 38 also comprises a plurality of first ribs which extend inwards from the channel 38b and are each received in one of the grooves 30 of the outer ring. Each first rib has a complementary shape to the associated groove 30. Each first rib projects relative to the channel 38b of the insulating insert. Each first rib is formed on the channel 38b during the overmolding of the insulating insert 38.

The insulating insert 38 also comprises a plurality of second ribs which extend inwards from the channel 38b and are each received in one of the grooves 32 of the outer ring. Each second rib has a complementary shape to the associated groove 32. Each second rib projects relative to the channel 38b of the insulating insert. Each second rib is formed on the channel 38b during the overmolding of the insulating insert 38.

The bearing device is manufactured as follows.

In a first step, the bearing 10 and the bushing 40 are mounted inside a mold that is provided for overmolding the insulating insert 38. In this position mounted inside the mold, the bushing 40 is radially spaced apart from the outer ring 14 of the bearing.

Then, in a consecutive second step, the insulating insert 38 is overmolded both on the outer ring 14 of the bearing and on the bushing 40. The first and second ribs of the insulating insert are formed during this step.

Finally, the bearing device, which is in the form of a unitary assembly, is removed from the mold.

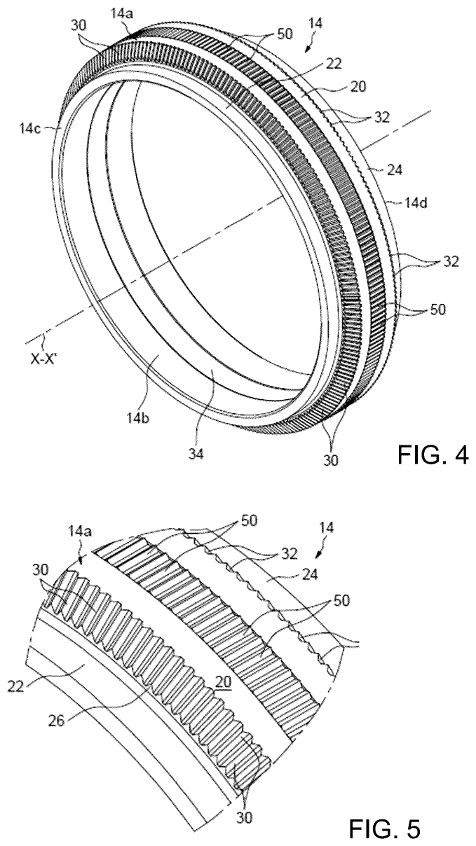

The exemplary embodiment illustrated in FIGS. 4 and 5, in which elements that are identical have the same references, differs from the preceding example in that the outer surface of the outer ring 14 is provided with third grooves 50 formed on the central part 20. The grooves 50 remain at a distance from the grooves 30, 32. The grooves 50 extend radially inwards from the central part 20. The grooves 50 are immediately adjacent to one another in the circumferential direction. Each groove 50 is circumferentially delimited by two facing lateral flanks which have a rectilinear profile in axial section and are connected to one another.

The grooves 50 are in this case formed all around the perimeter of the central part 20. As an alternative, the grooves 50 could extend over an angular sector less than 360°, or be arranged in the form of groups of grooves spaced apart from one another in the circumferential direction. The grooves 50 may be formed on the central part 20 by knurling. In a similar way to the first and second grooves, third ribs that extend inwards from the channel 38b and are each received in one of the grooves 50 of the outer ring are formed during the overmolding of the insulating insert.

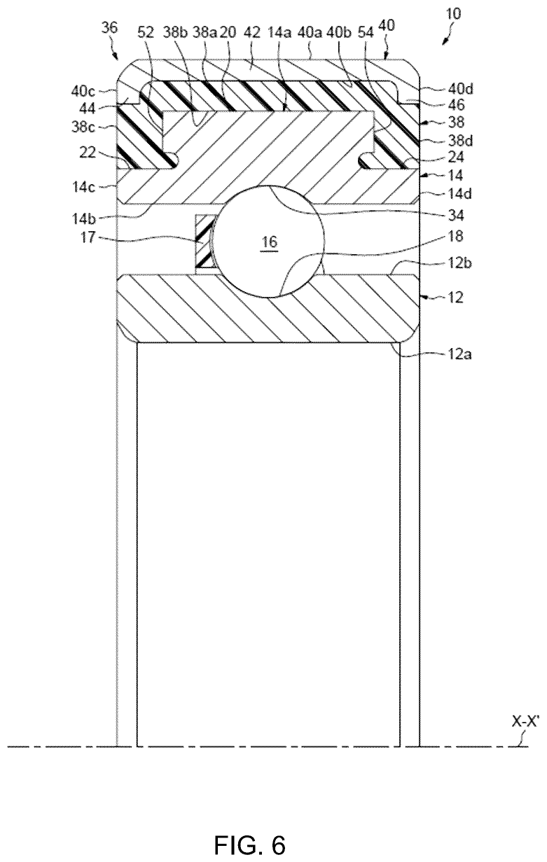

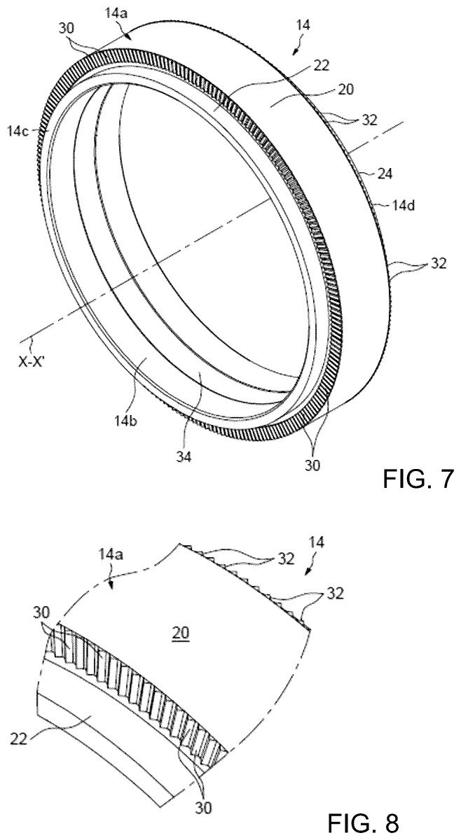

The exemplary embodiment illustrated in FIGS. 6 to 8, in which elements that are identical have the same references, differs from the first example in that the outer surface 14a has a first connection face 52 which extends between the first lateral part 22 and the central part 20 and has a radial part extending radially inwards from the central part 20 and a concave clearance which extends from a small diameter edge of the radial portion and is connected to the first lateral part 22. The grooves 30 are formed on the connection face 52, specifically, on the radial part of the connection face 52.

The outer surface 14a also has a second connection face 54 which extends between the second lateral part 24 and the central part 20 and has a radial part extending radially inwards from the central part 20, and a concave clearance which extends from a small diameter edge of the radial portion and is connected to the second lateral part 24. The grooves 32 are formed on the connection face 54, specifically, on the radial part of the connection face 54.

In one embodiment variant, it could also be possible to provide third grooves on the central part 20 of the outer surface of the outer ring, as described above.

In the illustrated embodiments, the first ring 12 of the bearing is the inner ring and the second ring 14, on which the insulating insert 38 is overmolded, is the outer ring.

As an alternative, it is possible to provide a reverse arrangement, in which the second ring 14, on which the insulating insert 38 is overmolded, is the inner ring. In this case, the insulating sleeve is located in the bore 12a of the inner ring. The insulating insert is then positioned radially between the bore 12a of the inner ring and the outer surface of the bushing. The insulating insert is overmolded on the outer surface of the bushing and on the bore of the inner ring, this bore being provided with grooves and forming the inner surface of the inner ring. The bore of the bushing delimits the bore of the bearing device.

In the described embodiments, the bearing of the device is provided with a single row of rolling elements. In a variant, the bearing can be provided with several rows of rolling elements. In addition, the rolling bearing can include types of rolling elements other than balls, for example rollers. In another variant, the bearing can be a plain bearing devoid of rolling elements.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved bearing devices having electrical insulation.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. A bearing device comprising:
a bearing including a first ring and a second ring configured to rotate relative to each other about a central axis, the second ring having a first axial end and a second axial end axially spaced from the first axial end and a first radial side extending from the first axial end to the second axial end and a second radial side extending from the first axial end to the second axial end, the second radial side being radially spaced from the first radial side,
a bushing, and
an electrically insulating insert overmolded between and connecting the bushing and the second radial side of the second ring,
wherein the second radial side of the second ring has a cylindrical central portion and a first cylindrical lateral part located axially between the cylindrical center portion and the first axial end of the second ring, the first cylindrical lateral part being radially offset from the cylindrical center portion,
wherein the second radial side of the second ring has a first connection face extending from the first cylindrical lateral part to the cylindrical center portion,
wherein the first connection face has a plurality of first circumferentially spaced grooves, and
wherein one of a plurality of first ribs of the electrically insulating bushing extends into a respective one of the plurality of first circumferentially spaced grooves.

2. The bearing device according to claim 1,
wherein at least a first portion of the first connection face is conical.

3. The bearing device according to claim 2,
wherein at least a second portion of the first connection face extends in a direction having a radial component.

4. The bearing device according to claim 3,
wherein the second portion of the first connection face extends in a purely radial direction.

5. The bearing device according to claim 1,
wherein at least a first portion of the first connection face extends in a direction having a radial component.

6. The bearing device according to claim 1,
wherein at least a first portion of the first connection face extends in a purely radial direction.

7. The bearing device according to claim 1,
wherein each of the plurality of first grooves is circumferentially delimited by two facing lateral flanks.

8. The bearing device according to claim 1,
wherein the first connection face includes a first conical portion extending from a first end of the cylindrical central portion and a second portion extending in a direction having a radial component from the first conical portion to the first cylindrical lateral part.

9. The bearing device according to claim 1,
wherein the first connection face includes a first conical portion extending from a first end of the cylindrical central portion and a second portion extending in a purely radial direction from the first conical portion to the first cylindrical lateral part.

10. The bearing device according to claim 1,
wherein the first connection face includes a first portion extending in a direction having a radial component from a first end of the cylindrical central portion or from the first cylindrical lateral part.

11. The bearing device according to claim 1,
wherein the first connection face includes a first portion extending in a purely radial direction from a first end of the cylindrical central portion or from the first cylindrical lateral part.

12. The bearing device according to claim 1, including a second cylindrical lateral part located axially between the cylindrical center portion and the second axial end of the second ring, the second cylindrical lateral part lying on a same first cylinder as the first cylindrical lateral part, and
a second connection face extending from the second cylindrical lateral part to the cylindrical center portion,
wherein the first connection face includes a first conical portion extending from a first end of the cylindrical central portion and a second portion extending in a direction having a radial component from the first conical portion to the first cylindrical lateral part,
wherein the second connection face includes a second conical portion extending from a second end of the cylindrical central portion and a second portion extending in a direction having a radial component from the second conical portion to the second cylindrical lateral part,
wherein the second connection face has a plurality of second circumferentially spaced grooves, and
wherein one of a plurality of second ribs of the electrically insulating bushing extends into a respective one of the plurality of second circumferentially spaced grooves.

13. The bearing device according to claim 12,
wherein the the second portion of the first connection face and the second portion of the second connection face lie on a same second cylinder.

14. The bearing device according to claim 13,
wherein the cylindrical central portion of the second ring includes a plurality of circumferentially spaced third grooves, and
wherein one of a plurality of third ribs of the electrically insulating bushing extends into a respective one of the plurality of third circumferentially spaced grooves.

15. The bearing device according to claim 14,
wherein the second ring is an outer ring and the first ring is an inner ring.

16. The bearing device according to claim 15,
wherein the bushing is made of metal.

17. An electric motor comprising:
a housing,
a shaft, and
at least one bearing device according to claim 16 mounted radially between the housing and the shaft.
